(19) United States
(12) Patent Application Publication
(10) Pub. No.: US 2009/0276553 A1
(43) Pub. Date: Nov. 5, 2009

(54) CONTROLLER, HARD DISK DRIVE AND CONTROL METHOD

(75) Inventor: Kenji Yoshida, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 12/345,387

(22) Filed: Dec. 29, 2008

(30) Foreign Application Priority Data
Apr. 30, 2008 (JP) 2008-118183

(51) Int. Cl. G06F 12/00; G06F 13/14; G06F 13/24

(52) U.S. Cl. 710/244; 710/240; 711/112; 711/E12.001; 710/52

(57) ABSTRACT

A data transfer system includes: a shared resource accessed from one or more devices; a plurality of request generation units each configured to generate a request for the device to access the shared resource, and output a remaining time value indicating how much time remains until the request is accepted before affecting an operation of an apparatus including the controller; and an arbitration unit configured to compare the remaining time values when the plurality of requests and the remaining time values are inputted from the plurality of request generation units, and give an access right to access the shared resource to a request with less remaining time.

### CROSS-REFERENCE TO RELATED APPLICATIONS

This application is based upon and claims the benefit of priority from the prior Japanese Patent Application No. 2008-118183, filed on Apr. 30, 2008; the entire contents of which are incorporated herein by reference.

### BACKGROUND OF THE INVENTION

1. Field of the Invention

The present invention relates to a controller used, for example, for electronic devices such as a hard disk drive, an image processor and a DVD player, a hard disk drive, and a control method.

2. Description of the Related Art

Generally, a hard disk drive has a bus control function which temporarily accumulates data in a shared resource such as a built-in memory for temporary storage before the data is written or read into/from a hard disk, and arbitrates requests to obtain a right (a bus priority) to preferentially use a bus connected with the shared resource.

As a conventional bus control technique, for example, a technique is disclosed which switches the bus priority according to the data amount in a storage memory which temporarily stored data and the data transfer speeds required by a plurality of request sources (see, for example, JP-A 2006-99473 (KOKAI)).

Incidentally, in the case of the hard disk drive, the host computer to which the drive is connected may become a pause state, or data transfer may be interrupted when the head reaches a position of a servo sector on the driven disk.

### BRIEF SUMMARY OF THE INVENTION

However, a problem in the above-described prior art is that the bus priority is determined according to the parameters due to the data amount in the memory for temporary storage and the data transfer speed, and therefore even if the data transfer is interrupted due to external factors such as a pause of the data transfer made by the host computer and the like and internal factors such as effects of the servo of the disk and the like, the bus priority is not shifted to another request, so that other requests are kept waiting, resulting in decreased use efficiency of the shared resource such as the memory for temporary storage.

The present invention has been developed to solve such a problem, and its object is to provide a controller, a hard disk drive, and a control method capable of improving the use efficiency of a shared resource.

A controller according to one aspect of the present invention includes: a shared resource accessed from one or more devices; a plurality of request generation units each configured to generate a request for the device to access the shared resource, and output a remaining time value indicating how much time remains until the request is accepted before affecting an operation of a whole apparatus including the controller; and an arbitration unit configured to compare the remaining time values when a plurality of requests and the remaining time values are inputted from the plurality of request generation units, and give an access right to access the shared resource to a request with less remaining time.

A hard disk drive according to one aspect of the present invention includes a hard disk unit driven by the controller according to claim 1.

A control method according to one aspect of the present invention generates requests for one or more devices to access a shared resource and remaining time values indicating how much time remains until the request is accepted before affecting an operation of a whole apparatus; compares the remaining time values when a plurality of requests and the remaining time values are generated; and gives an access right to access the shared resource to a request with less remaining time.

### BRIEF DESCRIPTION OF THE DRAWINGS

FIG. 1 is a diagram showing a configuration of a data transfer system in one embodiment.

FIG. 2 is a view showing a disk during a read operation.

FIG. 3 is a timing chart of signals in a disk read operation of a data transfer system.

FIG. 4 is a timing chart of signals in a request arbitration operation of the data transfer system.

### DETAILED DESCRIPTION OF THE INVENTION

Hereinafter, embodiments of the present invention will be described in detail with reference to the drawings.

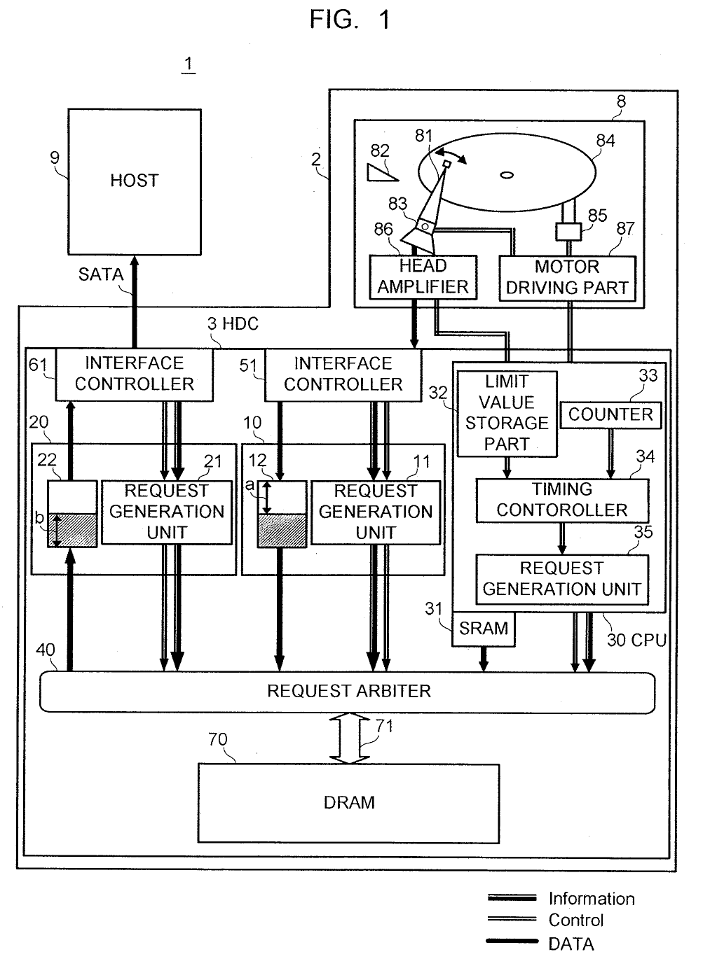

FIG. 1 is a block diagram showing a configuration of a data transfer system of one embodiment.

As shown in FIG. 1, the data transfer system 1 has a hard disk drive 2 and a host computer 9 (hereinafter, referred to as a “host 9”) to which the hard disk drive 2 is connected.

Note that in the drawing, bold lines show flows of data, and lines including white show control signals (control command, request and so on) or information (status) or the like.

The host 9 is a request source which makes a data transfer request to the hard disk drive 2 in this example.

The hard disk drive 2 has a hard disk controller 3 (hereinafter, referred to as an “HDC 3”) as one of controllers and a hard disk unit 8 (hereinafter, referred to as a “disk unit 8”).

The hard disk drive 2 reads data stored in the disk unit 8 and sends the data to the host 9, in response to a data transfer request from the host 9.

The HDC 3 has a first circuit group 10, a second circuit group 20, a central processing unit 30 (hereinafter, referred to as a “CPU 30”), an SRAM 31 that is a cache to prefetch program data, a request arbiter 40 as a request arbitration unit, a dynamic random access memory 70 (hereinafter, referred to as a “DRAM 70”) that is one of shared resources, a data processing circuit group (not shown) including an interface controller 61, and a data processing circuit group (not shown) including an interface controller 51.

The first circuit group 10 supplies data to a device (the disk unit 8 or the like) that is the request source via a FIFO buffer memory 12 (hereinafter, referred to as a “FIFO 12”).

The second circuit group 20 supplies data to a device (the host 9 or the like) that is the request source via a FIFO buffer memory 22 (hereinafter, referred to as a “FIFO 22”).

The interface controller 61 is connected to the host 9 via a serial ATA cable (a SATA cable) and an interface such as a SATA interface board.

The interface controller 51 is connected to the disk unit 8 via an interface bus (an internal bus).

The disk unit 8 has a head 81, a ramp 82, a voice coil motor 83, a disk 84, a spindle motor 85, a head amplifier 86, a motor driving part (motor driver) 87 and so on. The disk unit 8 is drive-controlled by the HDC 3.

Each of the interface controllers 51 and 61 is one of circuit groups which process data from the respective interfaces.

Other circuit groups include, for example, a read channel circuit, an error correction circuit, a decode circuit and so on.

The interface controller 51 detects the operating status of the disk unit 8 (the state of the disk unit 8 that the head 81 is writing data, reading data, or inserted into a servo sector) by communication with the disk unit 8 performed via the internal bus, and transmits a coefficient according to the detected state (an operating status coefficient A) to the first circuit group 10.

The interface controller 51 also serves as an interface with the disk unit 8.

The first circuit group 10 has a request generation unit 11 and the FIFO 12.

In this example, the first circuit group 10 shall perform processing of data read to the disk unit 8 for an easily understandable explanation.

The read data is once stored in the DRAM 70. Accordingly, the request generation unit 11 generates a request for data write to the DRAM 70.

Assuming that the fastest throughput at a point in time from the supply source (the disk unit 8 in this case) which supplies data to the FIFO 12 is a Byte/s, the number of bytes remaining in the FIFO 12 is a, and the operating status coefficient at the interface with the data supply source, to which write data is supplied is A, the request generation unit 11 finds the degree of grace (the remaining time) from the calculation expression of a/α×A and outputs the value of the degree of grace (the remaining time value) that is the calculation result to the request arbiter 40 at all times. The calculation expression to find the above-described degree of grace is only one example, and other various ways to find the degree of grace are conceivable.

The FIFO 12 is a first-in first-out buffer memory which stores inputted data in order and outputs the data in the order. In other words, the FIFO 12 is a buffer which buffers data supplied from devices such as the disk unit 8 in order and outputs the data in the order.

The interface controller 61 detects the communication status of the host 9 (the state of the host 9 that it is in a busy state, in a pause state (a waiting state), or in a state after completion of transfer) by communication with the host 9 performed via the SATA interface.

The interface controller 61 then generates a coefficient according to the detected communication status of the host 9 (an operating status coefficient B), and transmits the coefficient to the second circuit group 20.

The busy state refers to the state where the host 9 is actually transferring data.

As one example, a value of the operating status coefficient B=“1” when the host 9 is in a busy state, a value of the operating status coefficient B=“3” when it is in a pause state, and a value of the operating status coefficient B=“5” when it is in a state after completion of transfer, are set in advance in the interface controller 61.

The second circuit group 20 has a request generation unit 21 and the FIFO 22.

In this example, the second circuit group 20 shall generate a request for data read to the disk unit 8 in response to the request from the host 9 for an easily understandable explanation.

The request generation unit 21 generates a request for data read to a disk.

Assuming that the fastest throughput at a point in time at the transmission destination (the host 9 in this case) to which data is transmitted from the FIFO 22 is β Byte/s, the number of effective bytes currently existing in the FIFO 22 is b, and the operating status coefficient at the interface with the device that is the data supply destination (the host 9) to which read data is supplied is B, the request generation unit 21 finds the degree of grace from the calculation expression of b/β×B and outputs the value of the degree of grace that is the calculation result to the request arbiter 40 at all times.

The FIFO 22 is a first-in first-out buffer memory which stores inputted data in order and outputs the data in the order.

In other words, the FIFO 22 is a buffer which buffers data to be supplied to devices such as the host 9 in order and outputs the data in the order.

The CPU 30 has a limit value storage part 32, a counter 33, a timing controller 34, and a request generation unit 35.

The limit value storage part 32 stores a time value of a limit (a limit value) to refresh the DRAM 70.

In this example, assuming that the refresh timing of the DRAM 70 is, for example, 10 μsec, the limit value is smaller than that, for example, 9 μsec, and this value is stored in the limit value storage part 32.

The counter 33 repeatedly counts 0 to 9 μsec.

The timing controller 34 supplies a timing signal to generate a request to the request generation unit 35. The timing controller 34 outputs a timing signal, for example, every 9 μsec.

The request generation unit 35 reads the limit value from the limit value storage part 32, subtracts a value counted by the counter 33 from the limit value to find the degree of grace, and outputs the value of the degree of grace, to the request arbiter 40 at all times.

The request generation unit 35 also outputs a request (for example, a command such as a refresh cycle) to the request arbiter 40 when the request generation unit 35 is supplied with a timing signal from the timing controller 34.

The CPU 30 controls the disk unit 8 to perform data transfer and so on.

The CPU 30 also issues a refresh command, for example, every 10 μsec to the DRAM 70 to refresh the DRAM 70.

The refresh operation is important for the system, and is the highest priority request when the value of the degree of grace received from the request generation unit 35 is small, because missing of the refresh timing will affect the system most seriously.

When a request or requests and a degree or degrees of grace (remaining time) thereof are inputted from one or more of the requests generation units 11, 21 and 35, the request arbiter 40 compares their numerical values of the degrees of grace and selects a request with less remaining time.

The request arbiter 40 returns an access permission signal (grant: Gnt) to the generation source of the selected request in order to give an access right to the DRAM 70 to the issuing source of the selected request.

In this data transfer system, the types of the generation sources of requests are broadly classified into three.

### (Type I) First Circuit Group 10

The request is the write request to the DRAM 70, and the generation source of the request is the type having the FIFO 12 for data transmission.

In this case, the request generation unit 11 in the first circuit group 10 divides the number of bytes a remaining in the FIFO 12 by the value of the fastest throughput a at a point in time from the disk unit 8 to the FIFO 12 and multiplies the resulting value by the operating status coefficient A to calculate the degree of grace, and sends the value of the degree of grace to the request arbiter 40.

### (Type II) Second Circuit Group 20

The request is the read request to the DRAM 70, and the generation source of the request is the type having the FIFO 22 for data reception.

In this case, the request generation unit 21 in the second circuit group 20 divides the number of effective bytes b currently existing in the FIFO 22 by the fastest throughput P at a point in time from the FIFO 22 to the host 9 and multiplies the resulting value by the operating status coefficient B to calculate the degree of grace, and sends the value of the degree of grace to the request arbiter 40.

Note that each of the above-described type I and type II is the type using the FIFO, and they can also be realized as a piece of hardware as the request generation units in the circuit groups.

### (Type III) CPU 30

There are no FIFO and soon, but the request sent to the request arbiter 40 is a request expecting to be accepted within a given time.

In this case, the request generation unit 35 in the CPU 30 subtracts the current time from the time when the request should be accepted to calculate the value of grace, and sends the value to the request arbiter 40. In other words, the value of grace can be found by the time when the request should be accepted—the current time.

More specifically, in the case of the CPU 30, when the request is not accepted by the request arbiter 40 within a certain time, a request is issued which can affect the system (the whole hard disk drive 2).

Examples of the type III other than the example of the DRAM refresh include, for example, a mechanism which caches data in the SRAM 31, the code cache of the CPU 30 and so on.

In the code cache of the CPU 30, the difference between the read address pointer in the CPU 30 and the last cached address can be regarded as the number of effective bytes in the FIFO, and in this case, this type can be considered to be the same as the type II.

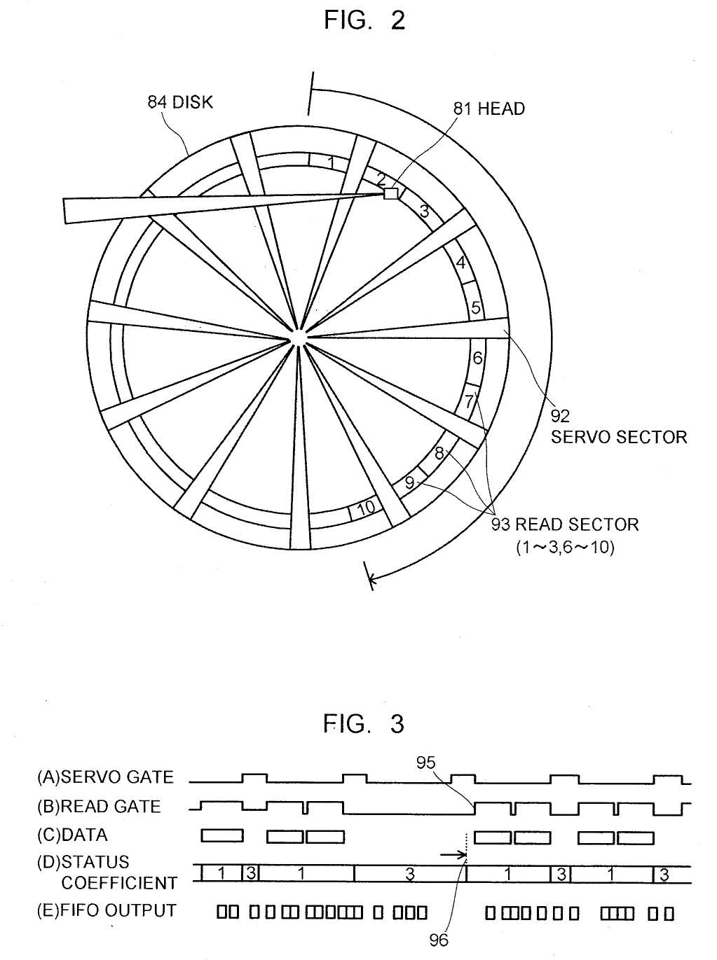

Hereinafter, the operation of the data transfer system will be described with reference to FIG. 2 to FIG. 4.

First, an example of the data read operation by the disk unit 8 will be described as one example to obtain the status coefficient of a device.

As shown in FIG. 2, servo sectors 92 and sectors 93 which are disk read targets are provided, for example, in the disk 84.

In this example, the read sectors 93 that are the targets shall be 1 to 3 and 6 to 10, and the head 81 shall read the sectors 92 and 93 at outer peripheral positions.

The timing chart in FIG. 3 shows changes in a signal (A) associated with opening/closing of the servo gate, a signal (B) associated with opening/closing of the read gate, data (C) on the disk interface bus (the internal bus), a status coefficient (D), and data (E) on the FIFO output data bus.

The status coefficient (D) shall be, for example, “1” during data read, “3” during interruption of data read, “5” after completion of data read and so on.

When the head 81 comes to above the servo sector 92 due to the rotation of the disk 84, the CPU 30 opens the servo gate (the signal (A) of the timing chart become HI) and the head 81 reads the positional information recorded on the servo sector 92.

The interface controller 51 is monitoring the operating status in this event.

Based on the read positional information, the CPU 30 senses the position of the head 81 and opens the read gate (the signal (B) becomes HI) to coincide with the position where the target read sector 92 exists.

The interface controller 51 changes, in coordination with the operation, the status coefficient at a position slightly before the timing when the read gate should be opened.

Specifically, the read gate is opened at the timing of, for example, a numeral 95 in the timing chart of FIG. 3 so that data is read from the disk 84, and the status coefficient “3” is changed to “1” at the position of a numeral 96 slightly before that timing.

Note that to speed up the processing, the degree of grace according to the throughput is not calculated every time in the request generation units 11 and 21, but the degree of grace is normalized in advance so that it is only necessary to multiply the degree of grace by the operating status coefficients A and B but not to perform division, whereby the processing speed can be further increased.

Assuming that throughputs of a plurality of request issuing sources are such that the fastest throughput of a first one is 30 MB/s, the fastest throughput of a second one is 60 MB/s, and the fastest throughput of a third one is 120 MB/s, the numbers of FIFO stages×{4, 2, 1} are the degrees of grace of the respective request issuing sources.

The operating status coefficients A and B are coefficients for applying computation to the degrees of grace according to the operating states of the interfaces of the origins (the host 9 and the disk unit 8) of data transmission and reception but not of the interfaces of FIFOs.

The operating status coefficients A and B are such that, for example, in the disk unit 8, data is transferred to the disk unit 8 only after the position of the head 81 reaches the target sector. Further, data transfer is not performed, for example, in the servo region even when one sector is being transferred.

Further, the read operation from a certain sector to another sector can be skipped in the disk unit 8.

As described above, the data transfer is interrupted frequently and for a comparatively long time between the disk unit 8 and the interface even when read data is being transferred to the DRAM 70.

Further, when the read operation with respect to the disk unit 8 is completed, the data are transferred to the DRAM 70 after being subjected to processing such as ECC correction.

The latency is extremely large but never affects the operation of the system even if the transfer request to the DRAM 70 is processed with a little margin, because in that case, if the read operation of data from the disk unit 8 has been completed, read of data thereafter is not performed.

As described above, when the actual data transfer is interrupted or completed at the interface, a certain computation (for example, one time under normal condition, three times during interruption in data transfer to the disk, five times after completion of data transfer to the disk and so on) is performed.

This allows more comprehensive optimization to cover the whole state. Though the operating status coefficients A and B may indicate the actual data transfer states in real time, it is too late to abruptly start the data transfer to the DRAM 70 after the data transfer is actually started.

Hence, it is more preferable to change the coefficients slightly earlier than the predictable point in time when the data transfer is actually performed.

For example, in the case where data is read from the disk 84 and transferred to the host 9, the CPU 30 of the HDC 3 manages the read sector that is the read sector number of the disk 84 and also manages the sector position where the head 81 currently exists.

In such a case, the interface controller 51 notifies the request generation unit 12 of the operating status coefficient B indicating that it is “during transfer” about one sector before starting the actual transfer, before start of read from the disk or during interruption of read from the disk.

The processing of selecting a high priority request from among a plurality of requests in the request arbiter 40 can employ various modes.

As one example, the simplest processing is to compare the degrees of grace sent from the respective request transmission sources and gives the access right to a request with less remaining time, that is, a small numerical value of the degree of grace.

In this case, the request arbiter 40 give the access right by returning the access permission signal (grant: Gnt) to the source to which the access right is given, to thereby permit access to the DRAM 70.

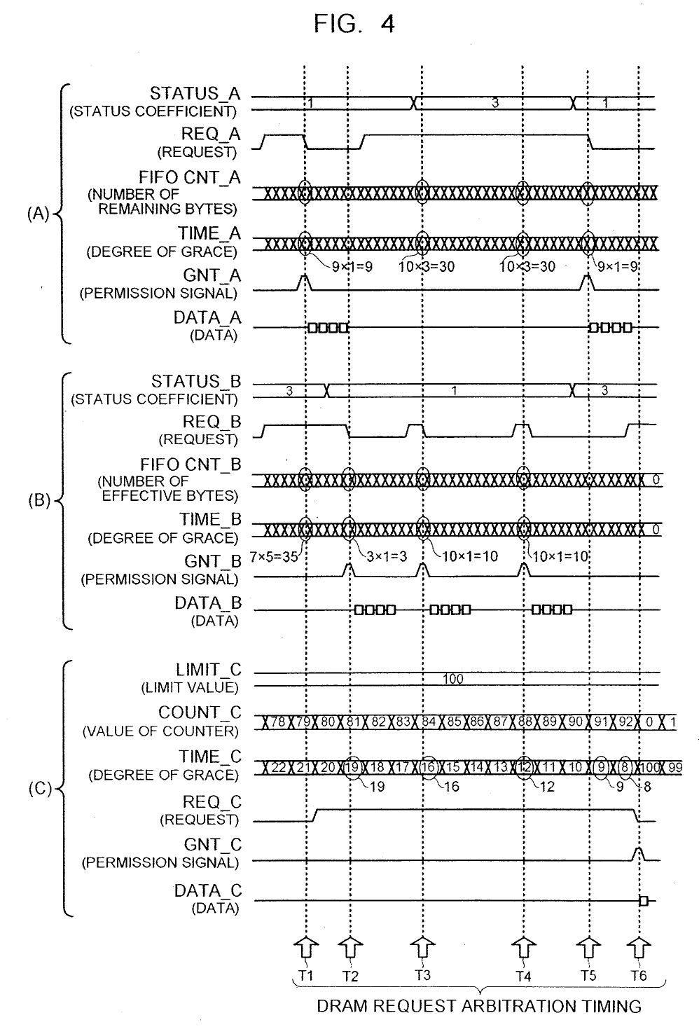

The request arbitration operation of the data transfer system will be described here with reference to the timing chart in FIG. 4.

FIG. 4 shows a signal group (A) relating to the request from the first circuit group 10 (the request generation unit 11), a signal group (B) relating to the request from the second circuit group 20 (the request generation unit 21), and a signal group (C) relating to the request from the CPU 30 (the request generation unit 35).

In the signal group (A), Status_A is a status coefficient of the disk unit 8 notified to the request arbiter 40 by the interface controller 51.

Req_A is a request issued from the request generation unit 11. FifoCNT_A is the number of bytes a remaining in the FIFO 12.

Time_A is the degree of grace notified to the request arbiter 40.

Gnt_A is the access permission signal returned from the request arbiter 40 to the request generation unit 11.

Data_A is data transferred to the DRAM 70.

In the signal group (B), Status_B is the status coefficient of the host 9 notified to the request arbiter 40 by the interface controller 61.

Req_B is a request issued from the request generation unit 21. FifoCNT_B is the number of effective bytes b in the FIFO 21.

Time_B is the degree of grace notified to the request arbiter 40.

Gnt_B is the access permission signal returned from the request arbiter 40 to the request generation unit 21.

Data_B is data transferred from the DRAM 70.

In the signal group (C), Limit_C is the limit value read from the limit value storage part 32.

The limit value indicates here not time but a numeric value (100) as the number of clocks.

This value can change from 0 to 99.

Time_C is the degree of grace notified to the request arbiter 40.

Time_C is the value obtained by simply subtracting the count value at that time from the limit value (100).

Req_C is a request for DRAM refresh issued from the request generation unit 35.

When the request is accepted, Count_C is reset to 0 and counting is started again.

Data_C is a refresh command sent to the DRAM 70.

Each of the refresh generation units 11, 21 and 35 accesses the DRAM 70 and then issues a request at timing when the next access becomes possible, for example, timings T1 to T8 at positions with arrows in the drawing.

The request arbiter 40 compares the degrees of grace at each of the timings T1 to T8, and issues a grant signal (one of Gnt_A, Gnt_B and Gnt_C) to the refresh generation unit having a smallest value of the degree of grace to permit access of the request.

This causes the request issuing source which has received the grant signal from the request arbiter 40 to actually access the DRAM 70 and perform data transfer.

In the case of this example, at the timing T1, Req_A and Req_B are issued and Time_A is “9” and Time_B is “35,” so that the request arbiter 40 outputs Gnt_A.

This causes Data_A to be transferred to the DRAM 70.

At the timing T2, Req_B and Req_C have been issued and Time_B is “3” and Time_C is “19,” so that the request arbiter 40 outputs Gnt_B to shift the access right. This causes Data_B to be transferred from the DRAM 70.

At the timing T3, Req A, Req_B and Req_C have been issued, and Time_A is “30”, Time_B is “10” and Time_C is “16,” so that the request arbiter 40 outputs Gnt_B not to shift the access right.

Thus, transfer of Data_B is continued.

At the timing T4, Req A, Req_B and Req_C have been issued, and Time_A is “30”, Time_B is “10” and Time_C is “12”.

The value of Status_A of Req_A is changed from “1” to “3” between the timing T3 and the timing T4, and the value of Time_A is higher than the others, in other words, the priority of Req_A is lowered, and therefore the request arbiter 40 outputs Gnt_B not to shift the access right.

Thus, transfer of Data_B is continued.

More specifically, Req_A will be kept waiting for access until the value of Status_A is changed to “1” so that the value of Time_A becomes lower than those of the other requests.

At the timing T5, Req_A and Req_C have been issued, and Time_A is “9” and Time_C is “10,” so that the request arbiter 40 outputs Gnt_A to shift the access right.

This causes Data_A to be transferred to the DRAM 70.

At the timing T6, Req_B and Req_C have been issued, and Time_B is “10” and Time_C is decreased to “8” immediately before it affects the operation performance, so that the request arbiter 40 outputs Gnt_C to immediately shift the access right to Req_C.

This causes Data_C to be transferred to the DRAM 70 so that refresh is performed in time.

Note that after Req_B is issued after the timing T6, FifoCNT_B that is the number of effective bytes in the FIFO 22 is “0”, that is, empty.

The pause state of the host 9 at that time locally causes an undesirable situation such as the FIFO empty in the data transfer to the host 9 but never broadly affects the performance of the hard disk.

According to the data transfer system of this embodiment, the request generation units 11 and 21 calculate the degrees of grace for the request sources, taking into consideration of not only the number of bytes a remaining in the FIFO 12 and the number of effective bytes b in the FIFO 22 and the throughputs α and β but also the communication statuses of the disk unit 8 and the host 9 (the operating status coefficients A and B), and send the calculated degrees of grace to the request arbiter 40, in order to obtain the access permission to the DRAM 70 that is the limited shared resource in the hard disk drive 2.

The request generation unit 35 further generates the degree of grace (numeric value) indicating how much time remains until the request is accepted by the request arbiter 40 before affecting the operation of this apparatus, and sends the generated degree of grace to the request arbiter 40.

Thus, the request arbiter 40 selects requests in order from a request with less remaining time from among the requests inputted thereto so as to prevent, as much as possible, an adverse effect from being exerted on the system, and returns the access permission signal (grant: Gnt) to the request source, thereby allowing the requests to access the DRAM 70 in order from a request with less remaining time.

Since the degree of grace is a numeric value and can be judged by a simple comparison processing, the requests to access the DRAM 70 can be efficiently arbitrated.

For example, when the host 9 pauses, the request generation unit 11 relatively lowers the priority of the request for host transfer. When the data transfer in the disk unit 8 is increased in speed at the outer peripheral side, the request generation unit 11 relatively increases the priority of the request for disk transfer.

On the other hand, when a margin is generated in the disk transfer due to reading of the servo sector 92, the request generation unit 11 relatively lowers the priority of data transfer to the disk unit 8 only at that time.

In other words, it is possible to quickly cope with the environment changing every moment to efficiently utilize the shared resource such as the DRAM 70.

More specifically, the access right is shifted according to the change in status of the whole drive or the whole system, in consideration of not only the periphery of the DRAM 70 that is the shared resource, the access bus 71, and the FIFO memories 12 and 22, but also the data read status in the disk unit 8 and the operating status of the host 9 such as a busy state or a pause state, so that the use efficiency of the shared resource can be increased.

The degree of grace described in the above-described embodiment is one example, and its number of digits may be changed into a form easy to calculate, or a numeric value indicating the degree of urgency may be used for expression in place of the degree of grace.

When requests have respective essential priority orders (for example, the disk transfer has a higher priority order than that of the host transfer in the hard disk drive 2 or the like), they may be multiplied by coefficients or may be provided with an upper limit or a lower limit of their degrees of grace in order to establish rank relationship among the priority orders.

Further, the request generation units 11, 21 and 35 may be used in combination with an existing arbitration circuit (a bus arbiter) other than that in the embodiment.

To realize an advanced arbitration unit, if the transfer times of the requests are different due to the difference in the number of bytes of one access, it may be preferable to permit, for example, a request with the second lowest degree of grace but a shortest access time to access first before permitting a request with the lowest degree of grace to access.

Such accesses never break either of the requests, but conversely when the request with the lowest degree of grace is permitted to access first, the request with the second lowest degree of grace will be broken because of a longer access time of the request with the lowest degree of grace.

When the arbitration unit is configured in consideration of such a case, the arbitration unit is configured to give once a temporary access right to the issuing source of the request with the lowest degree of grace, and if another request exists which has no grace until the point in time when the request issuing source of the request with the lowest degree of grace completes the data transfer, the arbitration unit gives the access right to the request source having no grace this time.

The arbitration unit is configured to give the access right according to the priorities inherent to the respective requests which haven bee previously determined, when a break occurs somewhere even if the arbitration unit gives the access right to any of a plurality of request issuing sources.

In an embodiment to actually configure the arbitration unit, the arbitration unit obtains the time for accepting the next request for each of requests from the respective access times, calculates for each of the requests whether or not there is another request which will break by the time for accepting the next request, and searches for a request in order from the lowest request until it finds the request which causes no break any of other requests.

When some of the requests will break, the requests may be processed according to the predetermined priorities, or the request with the lowest numeric value of the degree of grace may be processed.

Note that though the example in which the request generation units of the type I, the type II, and the type III are provided one each has been described in the above-described embodiment, various forms may be employed which are configured by combining the units of the type I and the type III, the units of the type II and the type III, and the units of the same type (the units of the type I, the units of the type II, and the units of the type III) and so on.

Though one example of the hard disk drive has been described in the above embodiment, a device of a request source connected to a controller having a shared resource via an interface can be applied also, for example, to an image processing device such as a color printer, consumer electronic devices such as a DVD recorder, a DVD player, a liquid crystal display device, and a television tuner, information processors such as a computer and a game machine.

### Other Embodiments

It should be noted that the present invention is not limited only to the above-describe embodiment, but the components may be modified in implementation phase without departing from the spirit of the present invention.

Further, various inventions can be made by combining a plurality of components disclosed in the above-described embodiment as necessary. For example, some components may be deleted from all of the components shown in the embodiment.

In other words, the embodiments of the present invention are not limited to the above-describe embodiment, but can be extended or changed, and the extended and changed embodiments are also included in the technical scope of the present invention.

What is claimed is:

1. A controller, comprising:
a shared resource accessible from one or more devices;
a plurality of request generation modules configured to generate a request for the one or more devices to access the shared resource, and output a remaining time value indicating how much time remains before an operation of a whole apparatus comprising the controller is affected; and
an arbitration module configured to compare a plurality of remaining time values when a plurality of requests and the plurality of remaining time values are inputted from the plurality of request generation modules, and give an access right to access the shared resource to a request with less remaining time.

2. The controller of claim 1, further comprising:
a buffer configured to buffer data supplied from the one or more devices in an order and output the data in the order; and
an interface controller configured to communicate with the one or more devices and detect a change in an operating state of the one or more devices during the communication, and generate a predetermined operating status coefficient corresponding to the detected operating state,
wherein at least one of the plurality of request generation modules generates a request for the one or more devices to access the shared resource, and generates the remaining time value based at least in part on a data transfer speed from the one or more devices to the buffer, an amount of data existing in the buffer or a remaining capacity of the buffer, and the operating status coefficient generated by the interface controller.

3. The controller of claim 2,
wherein when the request comprises a write request to the shared resource, at least one of the plurality of request generation modules calculates the remaining time value at least in part by dividing a number of bytes remaining in the buffer by a value of a fastest throughput at a point in time from the one or more devices to the buffer, and multiplying a resulting value by the operating status coefficient.

4. The controller of claim 2,
wherein when the request comprises a read request to the shared resource, at least one of the plurality of request generation modules calculates the remaining time value at least in part by dividing a number of effective bytes of data from the buffer by a value of a fastest throughput at a point in time from the buffer to the one or more devices, and multiplying a resulting value by the operating status coefficient.

5. The controller of claim 1,
wherein when the request comprises a request expected to be accepted within a given time, at least one of the plurality of request generation modules calculates the remaining time value by subtracting a current time from a time when the request should be accepted.

6. The controller of claim 1,
wherein the arbitration module is configured to give temporary access right to a request with a lowest remaining time value, and when there is a request with no remaining time until a point in time when data transfer of the request with the lowest remaining time value is completed, the arbitration module is configured to shift the access right to the request with no remaining time.

7. The controller of claim 1,
wherein the arbitration module is configured to give the access right according to a predetermined priority order of the requests when a break occurs.

8. A hard disk drive comprising a hard disk module driven by the controller of claim 1.

9. A control method in a controller having a plurality of request generation modules and an arbitration module, the method comprising:
generating, by a plurality of request generation modules, a plurality of requests for one or more devices to access a shared resource, and generating remaining time values indicating how much time remains before an operation of a whole apparatus is affected,
comparing, by the arbitration module, the remaining time values when the plurality of requests and the remaining time values are inputted from the plurality of request generation modules, and giving an access right to access the shared resource to a request with less remaining time.

10. The control method of claim 9,
wherein the controller comprises a buffer configured to buffer data supplied from the one or more devices in an order and output the data in the order; and an interface controller configured to communicate with the one or more devices and detect a change in an operating state of the one or more devices during the communication, and generate a predetermined operating status coefficient corresponding to the detected operating state; and
wherein at least one of the plurality of request generation modules generates a request for the one or more devices to access the shared resource, and generates the remaining time value based at least in part on a data transfer speed from the one or more devices to the buffer, an amount of data existing in the buffer or a remaining capacity of the buffer, and the operating status coefficient generated by the interface controller.

11. The control method of claim 10,
wherein when the request comprises a write request to the shared resource, at least one of the plurality of request generation modules calculates the remaining time value at least in part by dividing a number of bytes remaining in the buffer by a value of a fastest throughput at a point from the one or more devices to the buffer, and multiplying a resulting value by the operating status coefficient.

12. The control method of claim 10,
wherein when the request comprises a read request to the shared resource, at least one of the plurality of request generation modules calculates the remaining time value at least in part by dividing a number of effective bytes of data from the buffer by a value of a fastest throughput at a point in time from the buffer to the one or more devices, and multiplying a resulting value by the operating status coefficient.

13. The control method of claim 9,
wherein when the request comprises a request expected to be accepted within a given time, at least one of the plurality of request generation modules calculates the remaining time value by subtracting a current time from a time when the request should be accepted.

14. The control method of claim 9,
wherein the arbitration module is configured to give a temporary access right to a request with a lowest remaining time value, and when there is a request with no remaining time until a point in time when data transfer of the request with the lowest remaining time value is completed, the arbitration module is configured to shift the access right to the request with no remaining time.

15. The control method of claim 9,
wherein the arbitration module is configured to give the access right according to a predetermined priority order for the requests when a break occurs.

16. A control method, comprising:
receiving requests for one or more devices to access a shared resource and receiving remaining time values indicating how much time remains before an operation of a whole apparatus is affected,
comparing the remaining time values; and
giving an access right to access the shared resource to a request with less remaining time.
